(19) United States
(12) Patent Application Publication
(10) Pub. No.: US 2026/0023306 A1
(43) Pub. Date: Jan. 22, 2026

(54) LIGHT SOURCE MODULES FOR ADAPTIVE COLOR ADJUSTMENTS

(71) Applicant: Apple Inc., Cupertino, CA (US)

(72) Inventors: Nishant Tiwari, San Jose, CA (US); Yazan Z. Alnahhas, Stanford, CA (US); Terence N. Tam, Santa Clara, CA (US); Carey Tanner, San Francisco, CA (US); Florian R. Fournier, San Francisco, CA (US); Shohreh Shadalou, San Jose, CA (US)

(21) Appl. No.: 19/271,569

(22) Filed: Jul. 16, 2025

Related U.S. Application Data
(60) Provisional application No. 63/672,159, filed on Jul. 16, 2024.

(51) Int. Cl. G03B 15/03

(52) U.S. Cl. CPC G03B 15/03

(57) ABSTRACT

Systems, apparatuses, and methods for light source modules for adaptive color adjustments are described. A light source module includes a housing having a window, an emitter array, an accompanying emitter, and a lens. The emitter array includes a plurality of emitters, each emitter configured to emit light having a first color through the window. The accompanying emitter is configured to emit light having a second color through the window. The lens includes a first portion and a second portion. The first portion is positioned between the emitter array and the window, and configured to image the emitter array onto a field of illumination. The second portion is positioned between the accompanying emitter and the window, and the lens configured to direct the light emitted by the accompanying emitter to fill the field of illumination.

### CROSS-REFERENCE TO RELATED APPLICATIONS

This application claims the benefit under 35 U.S.C. § 119(e) of U.S. Provisional Patent Application No. 63/672,159, filed Jul. 16, 2024, the contents of which are incorporated herein by reference as if fully disclosed herein.

### TECHNICAL FIELD

The described embodiments relate generally to imaging devices and, more particularly, to systems, apparatuses, and methods for light source modules for adaptive color adjustments.

### BACKGROUND

Modern consumer electronic devices take many shapes and forms and have numerous uses and functions. Cameras continue to be an important feature of consumer electronics devices such as smartphones, tablets, and computers. The imaging capabilities of these consumer electronics devices have steadily increased as individual cameras have improved in quality and devices have started integrating multiple-camera (“multi-camera”) systems and depth sensors, allowing users to capture high quality images in an ever-increasing range of situations. In low light conditions, a light source module (also known as a “flash”) may be used to illuminate a scene to facilitate image capture. A light source module may also be used to provide illumination for a user in a torch mode. However, the illumination provided by a light source module may not fit the needs of certain situations. Thus, it may be desirable to provide light source modules with adjustable illumination.

### SUMMARY

Described herein are device and methods for light source modules for adaptive color adjustments.

Some aspects of this disclosure are directed to a light source module. The light source module includes a housing, an emitter array, an accompanying emitter, and a lens. The housing comprises a window. The emitter array comprises a plurality of emitters, each of which is configured to emit light having a first color through the window. The accompanying emitter is configured to emit light having a second color through the window. The lens includes a first portion positioned between the emitter array and the window, where the first portion is configured to image the emitter array onto a field of illumination. The lens further includes a second portion positioned between the accompanying emitter and the window, where the lens is configured to direct the light emitted by the accompanying emitter to fill the field of illumination.

Some aspects of this disclosure are directed to an imaging system. The imaging system includes a light source module. The light source module includes a housing, an emitter array, an accompanying emitter, and a lens. The housing comprises a window. The emitter array comprises a plurality of emitters, each of which is configured to emit light having a first color through the window. The accompanying emitter is configured to emit light having a second color through the window. The lens includes a first portion positioned between the emitter array and the window, where the first portion is configured to image the emitter array onto a field of illumination. The lens further includes a second portion positioned between the accompanying emitter and the window, where the lens is configured to direct the light emitted by the accompanying emitter to fill the field of illumination.

Some aspects of this disclosure are directed to a method of illuminating a scene. The method includes selecting one or more emitters of a plurality of emitters of an emitter array to use to illuminate a target portion of a field of illumination. The method further includes simultaneously operating the selected one or more emitters and an accompanying emitter to generate light of a first color and a second color to illuminate the scene. The method further includes capturing an image during the illumination, where the light of the first color illuminates the target portion of the field of illumination and the light of the second color illuminates the field of illumination.

Still other aspects of this disclosure are direct to a light source module. The light source module includes a housing with a window. The light source module further includes an emitter array having a plurality of emitters, each of which is configured to emit light having a first color through the window, and an accompanying emitter configured to emit light having a second color through the window. A rear surface of the window is configured to define a set of optical structures positioned at least partially over the emitter array.

In some variations, the set of optical structures includes a lens positioned at least partially over the emitter array. In some of these variations, the set of optical structures includes a set of Fresnel rings surrounding the lens. The set of optical structures may further include a set of concentric prisms surrounding lens and/or the set of Fresnel rings.

In some variations, the rear surface of the window defines a light guide positioned at least partially over the accompanying emitter and at least partially surrounding the set of optical structures. In some of these variations, the light guide encircles the set of optical structures. Additionally or alternatively, a bottom surface of the light guide may be configured as a prismatic surface having a plurality of concentric prisms. In some variations, the accompanying emitter may be a first accompanying emitter, and the light source module further includes a second accompanying emitter configured to emit light through the window. The light guide may be positioned at least partially over the second accompanying emitter. In some variations, the light source module may include a light sensor, wherein the light guide is positioned at least partially over the light sensor.

In some variations, the light source module includes an optical component positioned at least partially between the accompanying emitter and the window, wherein the optical component is positioned at least partially over the accompanying emitter. In some of these variations, the accompanying emitter is a first accompanying emitter, the light source module further includes a second accompanying emitter configured to emit light through the window, and the optical component is positioned at least partially over the second accompanying emitter. In some variations, the optical component includes an annular light guide. Additionally or alternatively, the optical component defines a lens positioned at least partially over the accompanying emitter. In some variations, the accompanying emitter is a first accompanying emitter, the optical component is a first optical component, and the light source module further includes: a second accompanying emitter configured to emit light through the window, and a second optical component positioned at least partially over the second accompanying emitter.

In addition to the exemplary aspects and embodiments described above, further aspects and embodiments will become apparent by reference to the drawings and by study of the following description.

### BRIEF DESCRIPTION OF THE DRAWINGS

To easily identify the discussion of any particular element or act, the most significant digit or digits in a reference number refer to the figure number in which that element is first introduced.

FIG. 1A shows a rear view of an illustrative example of a device including a light source module as described here. FIG. 1B depicts exemplary components of the device of FIG. 1A.

FIG. 2A shows a cross-sectional side view of an example of a light source module, as described here. FIG. 2B depicts a top view of a portion of the light source module of FIG. 2A.

FIG. 3A shows example fields of illumination for an emitter array of a light source module, as described here. FIG. 3B shows example fields of view for a camera corresponding to the fields of illumination of the emitter array.

FIG. 3C shows example fields of illumination for an emitter array of a light source module, as described here. FIG. 3D shows example fields of view for a camera corresponding to the fields of illumination of the emitter array.

FIG. 4A shows a cross-sectional side view of an example of a light source module, as described here. FIG. 4B depicts a top view of a portion of the light source module of FIG. 4A.

FIG. 5A shows a cross-sectional side view of an example of a light source module, as described here. FIG. 5B depicts a top view of a portion of the light source module of FIG. 5A.

FIG. 6A shows a cross-sectional side view of an example of a light source module, as described here. FIG. 6B depicts a top view of a portion of the light source module of FIG. 6A.

FIG. 7A shows a cross-sectional side view of an example of a light source module, as described here.

FIG. 7B shows a cross-sectional side view of an example of a light source module, as described here.

FIG. 8 shows an example method of illuminating a scene, according to certain aspects of the present disclosure.

FIGS. 9A and 9B show partial cross-sectional perspective views of variations of light source modules that include light guides, as described herein. FIG. 9C shows a top view of a portion of the light source module of FIG. 9A. FIGS. 9D-9F show cross-sectional side views of a portion of the light guide of FIG. 9A.

FIG. 10A shows a partial cross-sectional perspective view of an example of a light source module, as described herein. FIG. 10B shows a partial side view of the light source module of FIG. 10A.

FIG. 11A shows a partial cross-sectional perspective view of an example of a light source module, as described herein. FIGS. 11B and 11C show partial side views of variations of a portion of the light source module of FIG. 11A. FIG. 11D shows a partial cross-sectional perspective view of another example of a light source module, as described herein.

FIG. 12 shows an example method of illuminating a scene during a preflash operation, according to certain aspects of the present disclosure.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to light source modules for adaptive color adjustments. Consumer electronic devices frequently include a camera module with a light source module. A light source module (also known as a “flash”) of a camera may be used to illuminate a scene to facilitate image capture. Different scene conditions may benefit from different color and illumination across the scene. It may thus be desirable to provide a light source module with the flexibility to selectively change color of a scene and spatially vary the brightness of the illumination of a scene. A flash may also be used to provide illumination for a user in a torch mode, providing continuous illumination. For example, a flash in a torch mode may be used to illuminate an area around a user at night. However, existing flashes may bother a user's eyes and may have an undesirable impact on night vision of the user. The rods of a human eye are more sensitive to certain colors and night vision may be negatively affected by the use of higher-frequency colors of a typical white flash used in a torch mode.

Described herein are light source modules that include an emitter array to provide an adaptive light source of a first color and an accompanying emitter to provide light of a second color. In some variations, a light source module as described herein include an emitter array, an accompanying emitter, and a lens, each of which are positioned within a housing having a window. In other variations, a light source module may include an emitter array and an accompanying emitter positioned within a housing, and a lens that is integrated into a window of the housing. The emitter array includes multiple emitters, each emitter configured to emit light having a first color, for example white light. The accompanying emitter is configured to emit light having a second color, for example red light.

A wide variety of optical components may be used to route light from the emitter array and the accompanying emitter toward a scene. For example, in some variations the lens includes a first portion and a second portion. The first portion of the lens is positioned between the emitter array and the window. The first portion of the lens images the emitter array onto a field of illumination. The second portion of the lens is positioned between the accompanying emitter and the window. The lens directs the light emitted by the accompanying emitter to fill the field of illumination.

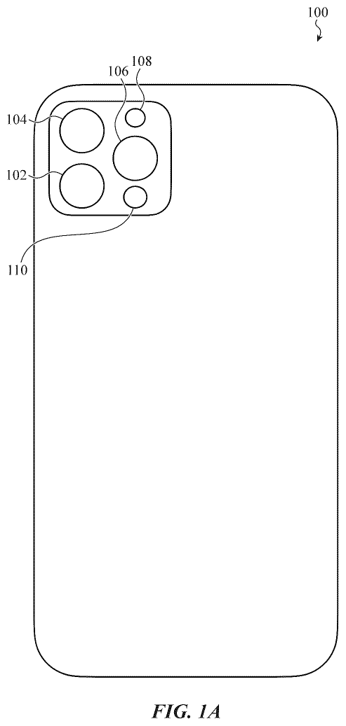

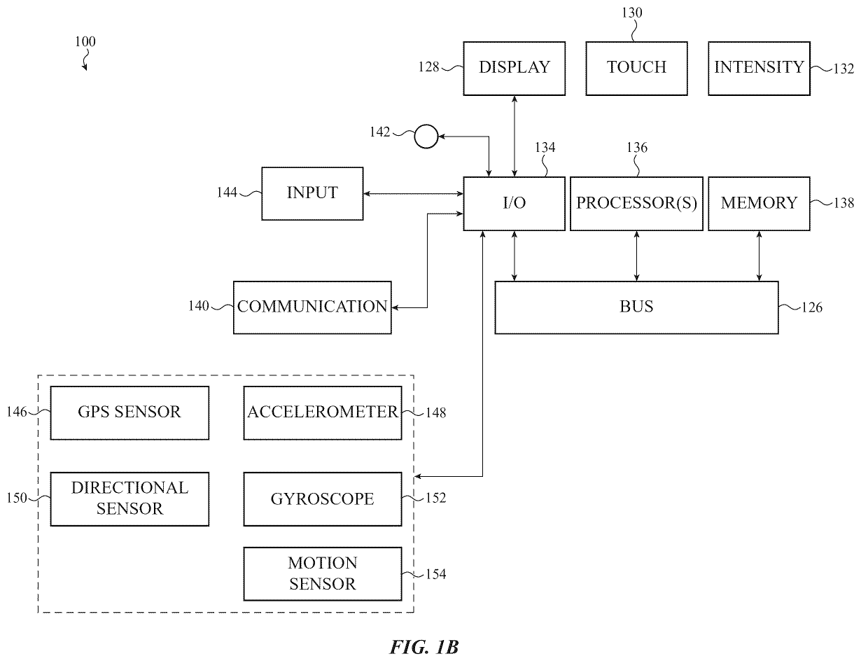

These and other embodiments are discussed below with reference to FIGS. 1A-8. However, those skilled in the art will readily appreciate that the detailed description given herein with respect to these figures is for explanatory purposes only and should not be construed as limiting.

The light source module described herein may be incorporated into a camera module, which in turn may be incorporated into an electronic device such as a phone, tablet, computer, or the like. FIG. 1A depicts an example device 100 as described herein. As shown, the device 100 includes a light source module 108. In instance where the light source module is used as a torch, the light source module may by configured to provide illumination that decreases impact on a user's night vision. In instance where the light source module is used to provide illumination during image capture, the light source module may be configured to provide a field of illumination suitable for specific photography situations.

In some instances, the first camera 102 is part of a multi-camera system. For example, in the variation shown in FIG. 1A, the first camera 102 is part of a multi-camera system having a second camera 104, and a third camera 106. A device 100 that includes a second camera 104 and/or third camera 106 may also include a light source module as described herein, but need not. It should be appreciated that the device 100 may include a single camera, or a multi-camera system having any number of cameras (with any relative positioning) as may be desired. Additionally, while shown as placed on the rear of a device 100, it should be appreciated that a camera having a light source module may be additionally or alternatively placed on the front (e.g., a front side having a display) or any other side of the device as desired.

In some instances, the device 100 may include a light source module 108. The light source module 108 may provide illumination to some or all of the fields of view of the cameras of the device 100 (e.g., the fields of view of the first camera 102, the second camera 104, and/or the third camera 106). This may assist with image capture operations in low light settings. The light source module 108 may produce a second color in addition to a first color. For example, the light source module 108 may produce red light in addition to a broader spectrum of visible light (e.g. white light) that is generally used in flash photography. The red light may make it easier to navigate or illuminate a user's surroundings. The red light may also provide additional options for illuminating a scene for image capture.

Additionally, or alternatively, the device 100 may further include a depth sensor 110 that may calculate depth information for a portion of the environment around the device 100. Specifically, the depth sensor 110 may calculate depth information within a field of coverage (i.e., the widest lateral extent to which the depth sensor is capable of providing depth information). The field of coverage of the depth sensor 110 may at least partially overlap the field of view of one or more of the cameras (e.g., the fields of view of the first camera 102, second camera 104, and/or third camera 106). The depth sensor 110 may be any suitable system that is capable of calculating the distance between the depth sensor 110 and various points in the environment around the device 100.

The depth information may be calculated in any suitable manner. In one non-limiting example, a depth sensor may utilize stereo imaging, in which two images are taken from different positions, and the distance (disparity) between corresponding pixels in the two images may be used to calculate depth information. In another example, a depth sensor may utilize structured light imaging, whereby the depth sensor may image a scene while projecting a known pattern (typically using infrared illumination) toward the scene, and then may look at how the pattern is distorted by the scene to calculate depth information. In still another example, a depth sensor may utilize time of flight sensing, which calculates depth based on the amount of time it takes for light (typically infrared) emitted from the depth sensor to return from the scene. A time-of-flight depth sensor may utilize direct time of flight or indirect time of flight, and may illuminate an entire field of coverage at one time, or may only illuminate a subset of the field of coverage at a given time (e.g., via one or more spots, stripes, or other patterns that may either be fixed or may be scanned across the field of coverage). In instances where a depth sensor utilizes infrared illumination, this infrared illumination may be utilized in a range of ambient conditions without being perceived by a user.

In some embodiments, the device 100 is a portable multifunction electronic device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. In other embodiments, the device 100 is a head-mounted device, such as an extended reality (XR) device, which may include augmented reality (AR) or virtual reality (VR) devices. Exemplary embodiments of head-mounted devices include, without limitation, the Vision Pro® device from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer, which may have a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content by transmitting, via a wired or wireless connection, data (e.g., image data or video data) to an integrated or external display generation component to visually produce the content.

FIG. 1B depicts exemplary components of the device 100. In some embodiments, device 100 has a bus 126 that operatively couples an I/O section 134 with one or more computer processors 136 and memory 138. The I/O section 134 can be connected to display 128, which can have touch-sensitive component 130 and, optionally, intensity sensor 132 (e.g., contact intensity sensor). In addition, I/O section 134 can be connected with communication unit 140 for receiving application and operating system data, using Wi-Fi, Bluetooth, near field communication (NFC), cellular, and/or other wireless communication techniques. The device 100 can include input mechanisms 142 and/or 144. Input mechanism 142 is, optionally, a rotatable input device or a depressible and rotatable input device, for example. Input mechanism 142 is, optionally, a button, in some examples. The device 100 optionally includes various sensors, such as GPS sensor 146, accelerometer 148, directional sensor 150 (e.g., compass), gyroscope 152, motion sensor 154, and/or a combination thereof, all of which can be operatively connected to I/O section 134. Some of these sensors, such as accelerometer 148 and gyroscope 152 may assist in determining an orientation of the device 100 or a portion thereof.

Memory 138 of the device 100 can include one or more non-transitory computer-readable storage mediums, for storing computer-executable instructions, which, when executed by one or more computer processors 136, for example, can cause the computer processors to perform the techniques that are described here (such as actuating the mechanical iris assemblies described herein). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The processor 136 can include, for example, dedicated hardware as defined herein, a computing device as defined herein, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of device 100, as well as to facilitate capturing of images as described herein. Device 100 is not limited to the components and configuration of FIG. 1B, but can include other or additional components in multiple configurations.

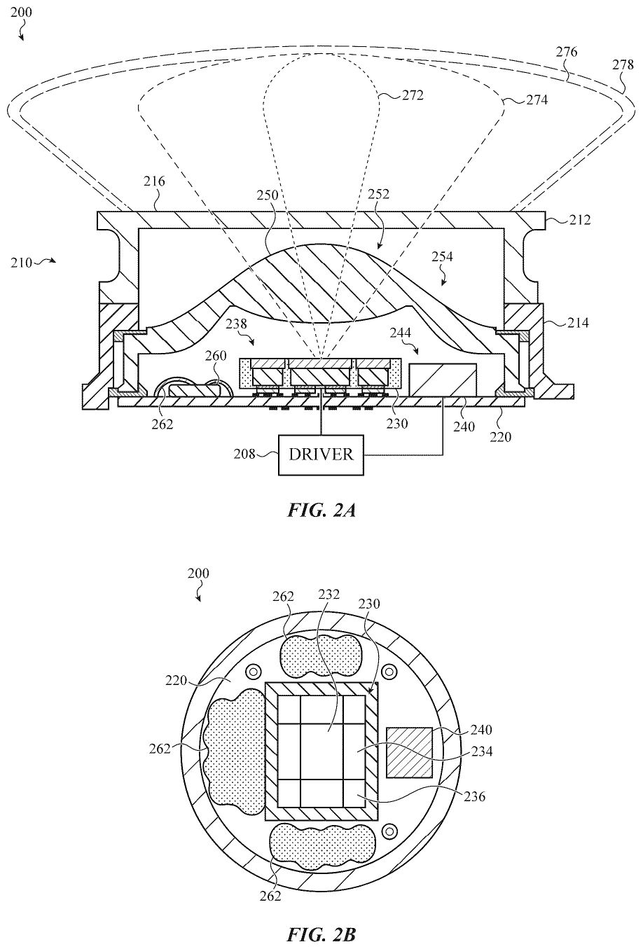

FIG. 2A shows a cross-sectional side view of an example of a light source module 200, as described here. FIG. 2B depicts a top view of a portion of the light source module 200. In one or more embodiments, the light source module 200 supports one or more aspects of light source modules for adaptive color adjustments, as further described herein.

Light source module 200 includes a housing. The housing may comprise a cap 210 that includes the window 216. In some variations, the cap 210 includes both a transparent portion 212 (which includes window 216) and a non-transparent portion 214.

The transparent portion 212 is configured to allow light from the emitter array 230 to leave the light source module (e.g., through window 216) to illuminate a scene. In some embodiments, the transparent portion 212 may include surface features, for example to collectively remove artifacts caused by gaps between adjacent emitters of the emitter array or otherwise selectively distort light to achieve a selected distortion profile. In some embodiment, the window 216 may include a plurality of concentric prisms positioned around a center point. The center point may or may not be aligned with a center of the housing. Each prism may extend from a surface of the housing and have an inner face that is angled toward the center point and an outer face that is angled away from the center point.

The non-transparent portion 214 of the cap 210 may be opaque or translucent to visible light. In some examples, the non-transparent portion 214 may be opaque or translucent to one or more non-visible wavelengths of light, such as infrared or ultraviolet light. In some examples, the non-transparent portion 214 may act to visibly obscure one or more portions of the light source module from external observation. For example, in some instances where the cap 210 is configured to contact a top surface of lens 250, an adhesive may be used to connect the cap 210 to the lens 250. In these instances, uneven application of the adhesive may be visible from outside the adaptive light source module with a fully transparent cap 210. The non-transparent portion 214 of the cap 210 may be positioned above the adhesive to limit visibility of the adhesive through a top portion (transparent portion 212) of the cap 210. Additionally or alternatively, the non-transparent portion 214 may limit or prevent light from passing therethrough, which in turn may be used to reduce stray light that may exit the light source module into the overall device (which may interfere with other device components) and/or enter the light source module from the overall device (which may interfere with any light sensor positioned inside the light source module). In some configurations, the light source module may be positioned at least partially within a device so that light may be limited to enter and exit the image source module through the window 216.

In the variation shown in FIGS. 2A and 2B, the window 216 is formed from a transparent material (e.g., from the transparent portion 212 of the cap 210) that does not scatter light passing through the transparent material. It should be appreciated that in other instances, the window 216 may be formed from a translucent material that scatters light as it passes through the translucent material. Forming the window 216 from a translucent material may act to blur light passing through the window 216, which may obscure visibility of components positioned under the window. In some variations, the entire cap 210 may be formed from one or more translucent materials. In other variations, the cap 210 may include a translucent portion that includes the window 216 (e.g., configured as shown with respect to the transparent portion 212 in FIGS. 2A and 2B) and an opaque portion (e.g., configured as shown with respect to the non-transparent portion 214 in FIGS. 2A and 2B).

The light source module 200 further includes substrate 220, which may support an emitter array 230 and an accompanying emitter 240. In some examples, the substrate 220 may include passive and active electrical components to support the operation of the emitter array 230 and the accompanying emitter 240. In some examples, the substrate 220 may further include a light sensor 260, which may be capable of measuring one or more aspects of ambient light received from the scene. Such aspects may include brightness, color temperature, flicker information, and the like. The light sensor 260 may include a protective layer 262 that may be used to isolate a component from surrounding air and/or may obscure visibility of that component from outside of the light source module 200.

The substrate 220 supports the emitter array 230. The emitter array 230 may comprise a plurality of individual emitters each capable of emitting light of a first color. In some embodiments, the first color is a broad spectrum of visible light (e.g., white light). In some embodiments, the plurality of individual emitters includes a central emitter 232 and eight peripheral emitters surrounding the central emitter 232. In the example of the emitter array 230, the eight peripheral emitters include four side peripheral emitters 234 and four corner peripheral emitters 236. Although the emitter array 230 is illustrated having nine emitters, other configurations may also be used. While shown in FIG. 2B as a 3×3 array, it should be appreciated that the emitter array 230 may comprise any suitable number and arrangement of emitters, such as, for example, a 2×3 array, a 2×4 array, a 3×4 array, a 4×4 array or the like.

The emitter array 230 may be an array of light emitting diodes (LED). The emitter array 230 may comprise any emitters capable of generating light (e.g., semiconductor lasers or the like). In some embodiments, the emitters of the emitter array 230 may be formed on a single common substrate. In other embodiments, the emitters of the emitter array 230 may be formed separately and then mounted on a substrate to form the emitter array 230 (e.g., mounted on substrate 220 to form the emitter array 230, or mounted on a substrate to form the emitter array 230, which is in turn mounted on substrate 220).

The substrate 220 further supports an accompanying emitter 240. The accompanying emitter 240 may be an emitter capable of generating light of a second color. In some embodiments, the second color is red, and the accompanying emitter 240 is a red LED. In some cases, the accompanying emitter 240 may be another color, or combination of colors. In one or more embodiments, the emitter array 230 has a first light-emitting surface 238, and the accompanying emitter 240 has a second light-emitting surface 244 oriented in a same direction as the first light-emitting surface 238 of the emitter array 230. In other embodiments, the first light-emitting surface 238 and the second light-emitting surface 244 may be oriented in different directions.

A lens 250 is positioned between the emitter array 230 and the window 216 of the transparent portion 212 of the cap 210. In some embodiments, lens 250 may be fixed against the non-transparent portion 214 and secured with an adhesive. The substrate 220 may then be positioned and fixed against the lens 250 and secured with an adhesive.

The lens 250 may have a first portion 252 that is generally positioned between the emitter array 230 and the window 216. This first portion 252 is configured to image the emitter array 230 onto a field of illumination. The lens 250 may also have a second portion 254 that is generally positioned between the accompanying emitter 240 and the window 216. The second portion 254 of the lens 250 may be configured to direct light from the accompanying emitter 240 to fill the field of illumination.

The lens 250 may focus, collimate, or otherwise shape light emitted by the emitter array 230 and the accompanying emitter 240. The size and shape of the emitters of the emitter array 230, the size and shape of the accompanying emitter 240, the design of the lens 250, and the relative positioning between the emitter array 230, the accompanying emitter 240, and the lens 250 may all impact the size, shape, and position of the field of illumination of the light source module 200.

During operation, light emitted by the emitter array 230 may be directed by the lens 250 with a beam size and/or shape that depends on the emitter that is energized and emitting light. In particular, for the emitter array 230, when the central emitter 232 is energized, and the remaining emitters unenergized, then the beam size and/or shape for the resultant beam may correspond to beam 272. When the central emitter 232 and four side peripheral emitters 234 are energized, and the remaining emitters unenergized, then the beam size and/or shape for the resultant beam may correspond to beam 274. When all the emitters of the emitter array 230 (the central emitter 232, the four side peripheral emitters 234, and the four corner peripheral emitters 236) are energized, then the beam size and/or shape for the resultant beam may correspond to beam 276.

Similarly, during operation, light emitted by the accompanying emitter 240 may be directed by the lens 250 with a beam size and/or shape for the resultant beam corresponding to beam 278. The lens 250 is configured to direct the light emitted by the accompanying emitter 240 to fill the field of illumination of the emitter array 230.

A driver 208 may be coupled with both the emitter array 230 and the accompanying emitter 240 to provide signals (e.g., power and control signals) to the emitters of the emitter array 230 and the accompanying emitter 240. The provided signals determine which emitters are stimulated to emit light, and the voltage and current applied to an individual emitter. In some embodiments, the driver 208 may be fixed to the substrate 220 on an opposite face from the emitter array 230 and the accompanying emitter 240. In other embodiments, the driver 208 may be separate from the substrate 220. In one or more embodiments, the driver 208 may be coupled with the light sensor 260 so that the driver 208 can adjust signals provided to the emitter array 230 and the accompanying emitter 240 based on an ambient light level.

In some embodiments, the window 216 may have, on the surface facing the lens 250, a set of concentric prisms to create distortions in the light. In particular, the distortions may be used to address image artifacts resulting from spacing between adjacent emitters of the emitter array. Specifically, the prisms may be configured to distort light produced by the emitter array 230 in order to cause partial overlap between the light emitted by adjacent emitters.

In general, the prisms of the prismatic surface of the window 216 preferably have sufficient optical power to create enough overlap to fill the gaps between adjacent emitters in the light pattern received from the emitter array 230. As the optical power starts to increase, the distortions will start to cause light emitted from one emitter of the emitter array 230 to overlap in the scene with light emitted from a second emitter of the emitter array 230. This may negatively impact the operation of the device, as this overlap may impair the adaptive light source module's ability to provide relatively uniform illumination to a scene. Accordingly, it may be desirable to configure the prismatic surface of the window 216 to provide sufficient distortion to fill the gaps in a light pattern received by the prismatic surface.

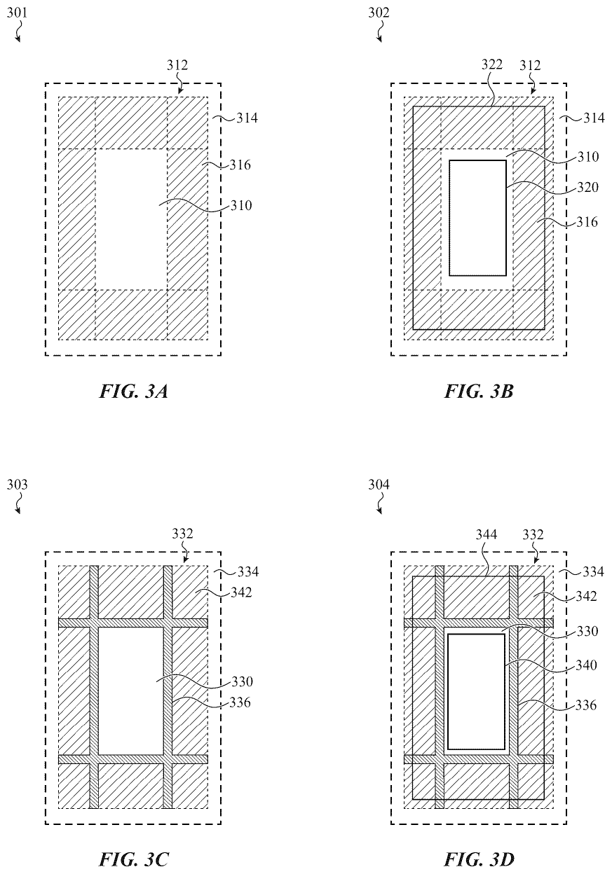

FIG. 3A shows example fields of illumination 301 for a light source module that includes an emitter array with accompanying emitter as described herein, according to certain aspects of the present disclosure. In one or more embodiments, the light source module may be an example of a light source module 200, or another light source module described herein.

The fields of illumination 301 include a field of illumination 312, a first portion 310 of the field of illumination 312, a second portion 316 of the field of illumination 312, and a field of illumination 314. The field of illumination 312 corresponds to the whole emitter array. The field of illumination 312 is the widest lateral extent in a scene to which the emitter array 230 of the light source module 200 is capable of illuminating. The first portion 310 of the field of illumination 312 corresponds to a central emitter of the emitter array 230. The second portion 316 of the field of illumination 312 corresponds to the four side peripheral emitters 234 and the four corner peripheral emitters 236 of the emitter array 230. The field of illumination 314 corresponds to the accompanying emitter 240.

As shown for the fields of illumination 301, the emitter array 230 may provide different illumination to different portions a scene, including the field of illumination 312 and the field of illumination 314. The field of illumination 314 fills the field of illumination 312.

FIG. 3B shows example fields of view 302 for cameras corresponding to fields of illumination (e.g., the fields of illumination 301) for an emitter array with accompanying emitter of a light source module as described herein, according to certain aspects of the present disclosure.

The fields of view include a first field of view 320 of a first camera. The first camera may be one of the first camera 102, the second camera 104, or the third camera 106 of the camera module described with reference to the device 100. The first field of view 320 may be within the first portion 310 of the field of illumination 312, for example so that when a central emitter 232 of the emitter array 230 is emitting light for the first portion 310 of the field of illumination 312, the first portion 310 of the field of illumination 312 fills the first field of view 320. Similarly, when the accompanying emitter 240 is operated to emit light corresponding to the field of illumination 314, the field of illumination 314 fills the first field of view 320. The central emitter 232 and the accompanying emitter 240 may be operated together at the same time, or may be operated individually.

The fields of view also include a second field of view 322 of a second camera. The second camera may be one of the first camera 102, the second camera 104, or the third camera 106 of the camera module described with reference to the device 100. The second camera may be a different camera than the first camera. The second field of view 322 may be within the field of illumination 312, for example so that when all the emitters of the emitter array 230 (e.g., the central emitter 232, the four side peripheral emitters 234, and the four corner peripheral emitters 236) are emitting light for the field of illumination 312, the field of illumination 312 fills the second field of view 322. Similarly, when the accompanying emitter 240 is operated to emit light corresponding to the field of illumination 314, the field of illumination 314 fills the second field of view 322. The emitters of the emitter array 230 (e.g., the central emitter 232, the four side peripheral emitters 234, and the four corner peripheral emitters 236) and the accompanying emitter 240 may be operated together at the same time, or may be operated individually.

FIG. 3C shows example fields of illumination 303 for a light source module that includes an emitter array with accompanying emitter as described herein, according to certain aspects of the present disclosure. In one or more embodiments, the light source module may be an example of a light source module 200, or another light source module described herein. The example fields of illumination 303 may illustrate overlapping fields of illumination of emitters of an emitter array.

The fields of illumination 303 include a field of illumination 332, a first portion 330 of the field of illumination 332, a second portion 342 of the field of illumination 332, and a field of illumination 334. The field of illumination 332 corresponds to the whole emitter array. The field of illumination 332 is the widest lateral extent in a scene to which the emitter array 230 of the light source module 200 is capable of illuminating. The first portion 330 of the field of illumination 332 corresponds to a central emitter of the emitter array 230. The second portion 342 of the field of illumination 332 corresponds to the four side peripheral emitters 234 and the four corner peripheral emitters 236 of the emitter array 230. The field of illumination 334 corresponds to the accompanying emitter 240.

As shown for the fields of illumination 303, fields of illumination for the various adjacent emitters of the emitter array may overlap at an overlapping portion 336. Some of the field of illumination 332 of the emitter array 230 are illuminated by a single emitter. Near the boundaries between adjacent emitters, however, the illumination from one emitter may partially overlap the illumination from another emitter. This is illustrated by an overlapping portion 336 of the field of illumination 332, which represents the portions of the field of illumination 332 that may be illuminated by two or more emitters of the emitter array 230.

As shown for the fields of illumination 303, the emitter array may provide different illumination to different portions of a scene, including the first portion 330 of the field of illumination 332 and the second portion 342 of the field of illumination 332. The field of illumination 334 fills the field of illumination 332.

FIG. 3D shows example fields of view 304 for cameras corresponding to fields of illumination (e.g., the fields of illumination 303) for an emitter array with accompanying emitter of a light source module as described herein, according to certain aspects of the present disclosure. The example fields of view 304 may illustrate overlapping fields of illumination of emitters of an emitter array.

The fields of view include a first field of view 340 of a first camera. The first camera may be one of the first camera 102, the second camera 104, or the third camera 106 of the camera module described with reference to the device 100. The first field of view 340 may be within the first portion 330 of the field of illumination 332, including within the overlapping portion 336, so that when a central emitter 232 of the emitter array 230 is emitting light for the first portion 310 of the field of illumination 332, the first portion 330 of the field of illumination 332 fills the first field of view 340. Similarly, when the accompanying emitter 240 is operated to emit light corresponding to the field of illumination 334, the third field of illumination 334 fills the first field of view 340. The central emitter 232 and the accompanying emitter 240 may be operated together at the same time, or may be operated individually.

The fields of view also include a second field of view 344 of a second camera. The second camera may be one of the first camera 102, the second camera 104, or the third camera 106 of the camera module described with reference to the device 100. The second camera may be a different camera than the first camera. The second field of view 344 may be within the field of illumination 332, including within the overlapping portion 336, for example so that when all the emitters of the emitter array 230 (e.g., the central emitter 232, the four side peripheral emitters 234, and the four corner peripheral emitters 236) are emitting light for the field of illumination 332, the field of illumination 332 fills the second field of view 344. Similarly, when the accompanying emitter 240 is operated to emit light corresponding to the field of illumination 334, the third field of illumination 334 fills the second field of view 344. The emitters of the emitter array 230 (e.g., the central emitter 232, the four side peripheral emitters 234, and the four corner peripheral emitters 236) and the accompanying emitter 240 may be operated together at the same time, or may be operated individually.

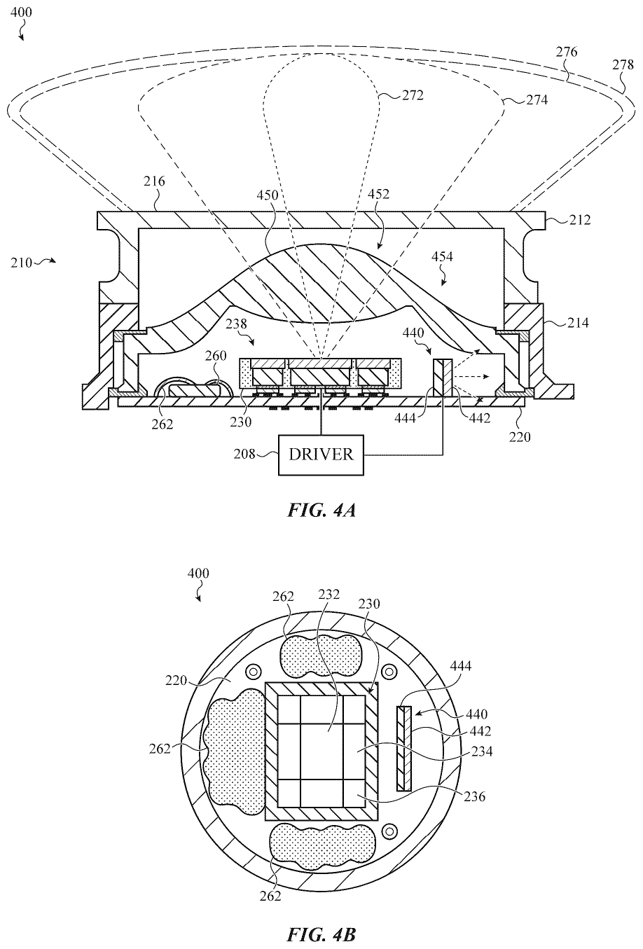

FIG. 4A shows a cross-sectional side view of an example of a light source module 400, as described here. FIG. 4B depicts a top view of a portion of the light source module 400. In one or more embodiments, the light source module 400 supports one or more aspects of light source modules for adaptive color adjustments, as further described herein. The light source module 400 includes similar features as the light source module 200, except as indicated here, and duplicative description is omitted for clarity.

In the example of the light source module 400, the emitter array 230 has a light-emitting surface 238, and the accompanying emitter 440 has a light-emitting surface 442 oriented in a different direction than the light-emitting surface of the emitter array 230. For example, the accompanying emitter 440 may have a light-emitting surface 442 oriented to face away from the emitter array (e.g., an accompanying emitter 440 may be configured to side-fire). A light-emitting surface 442 of the accompanying emitter 440 is oriented to face away from the emitter array 230, such that emitted light is directed away from the emitter array 230. A back surface 444 of the accompanying emitter 440 is generally oriented to face toward the emitter array 230.

Lens 450 has a first portion 452 that is generally positioned between the emitter array 230 and the window 216. The first portion 452 of the lens 450 is that portion of the lens 450 that is configured to image the emitter array 230 onto the field of illumination. The lens 450 also has a second portion 454 that is generally positioned between the accompanying emitter 440 and the window 216. This second portion 454 of the lens 450 is that portion of the lens 450 that is configured to direct light emitted from the accompanying emitter to fill the field of illumination of the emitter array 230.

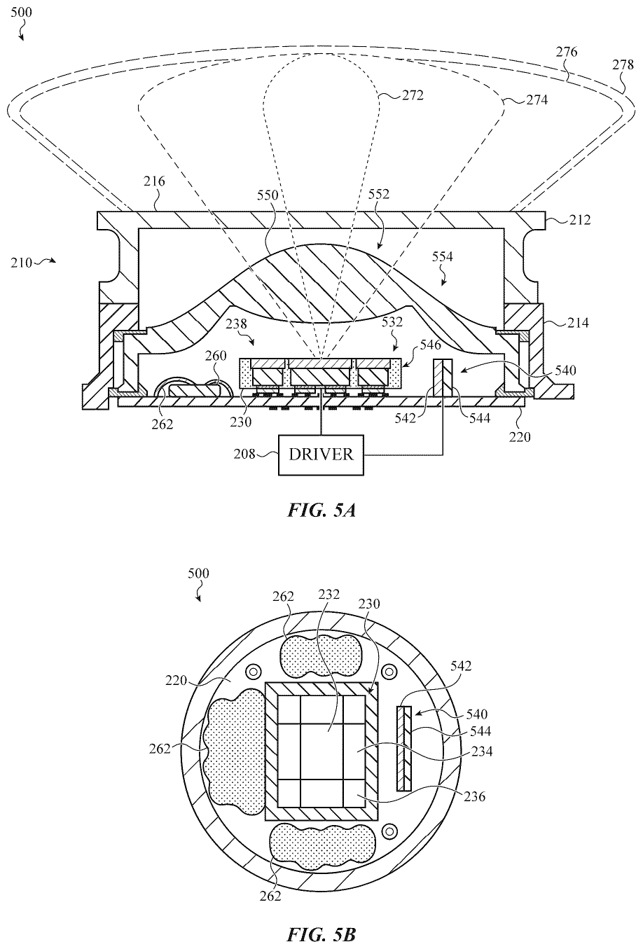

FIG. 5A shows a cross-sectional side view of an example of a light source module 500, as described here. FIG. 5B depicts a top view of a portion of the light source module 500. In one or more embodiments, the light source module 500 supports one or more aspects of light source modules for adaptive color adjustments, as further described herein. The light source module 500 includes similar features as the light source module 200 and the light source module 400, except as indicated here, and duplicative description is omitted for clarity.

In the example of the light source module 500, an accompanying emitter 540 is configured to side-fire. A light-emitting surface 542 of the accompanying emitter 540 is oriented to face toward the emitter array 230, such that emitted light is generally directed toward the emitter array 230. The light-emitting surface 542 and the light-emitting surface 238 are oriented in different directions. A back surface 544 of the accompanying emitter 540 is generally oriented to face away from the emitter array 230.

In one or more embodiments, the emitter array 230 may have reflective portions to aid in light reflection and dispersion. In particular, side surfaces 546 and/or a perimeter portion 532 of the emitter array 230 may be metallic or covered in a reflective coating to at least partially reflect light emitted from the accompanying emitter 540. The side surfaces 546 of the emitter array 230 include portions of the emitter array 230 oriented in a different direction than the light-emitting surface. The perimeter portion 532 may include portions of the emitter array 230 other than the light-emitting surface (e.g., the central emitter 232, the four side peripheral emitters 234, and the four corner peripheral emitters 236).

Lens 550 has a first portion 552 that is generally positioned between the emitter array 230 and the window 216. The first portion 552 of the lens 550 is that portion of the lens 550 that is configured to image the emitter array 230 on the field of illumination. The lens 550 also has a second portion 554 that is generally positioned between the accompanying emitter 540 and the window 216. This second portion 554 of the lens may be configured to direct light emitted from the accompanying emitter 440 to fill the field of illumination of the emitter array 230.

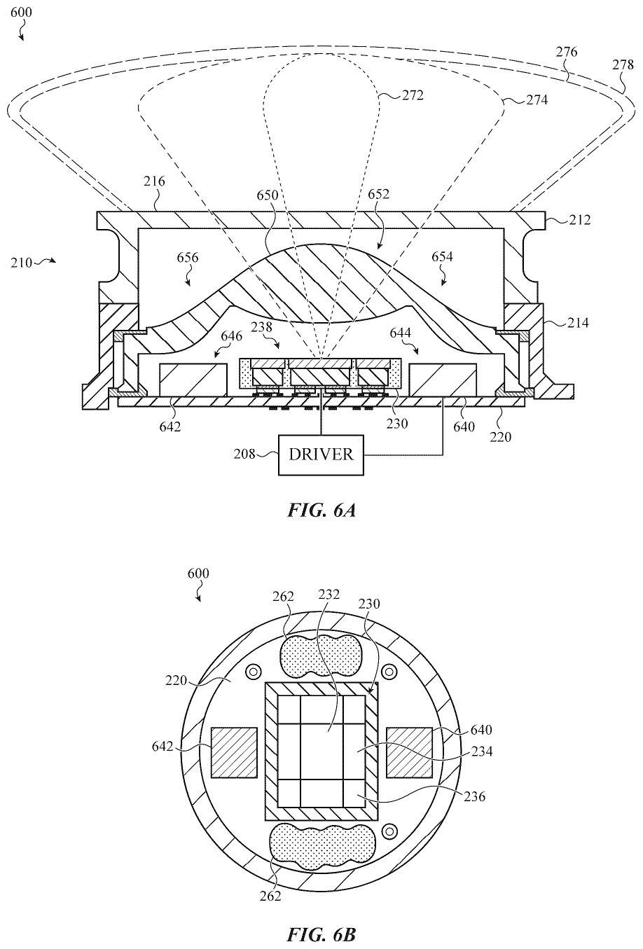

FIG. 6A shows a cross-sectional side view of an example of a light source module 600, as described here. FIG. 6B depicts a top view of a portion of the light source module 600. The light source module 500 includes similar features as the light source module 200, the light source module 400, and the light source module 500, except as indicated here, and duplicative description is omitted for clarity.

In the example of the light source module 600, there is both a first accompanying emitter 640 and a second accompanying emitter 642. The first accompanying emitter 640 and/or the second accompanying emitter 642 may be configured as described with respect to the accompanying emitter 240 described herein. The first accompanying emitter 640 has a light-emitting surface 644. The second accompanying emitter 642 has a light-emitting surface 646. Both the first accompanying emitter 640 and the second accompanying emitter 642 may be positioned and configured generally such that their respective light-emitting surface 644 and light-emitting surface 646 emit in a direction away from the substrate 220 and toward the window 216 through the lens 650. The light-emitting surface 644 and the light-emitting surface 646 may be oriented to emit in a same direction. In other embodiments, the light-emitting surface 644 and the light-emitting surface 646 may be oriented in different directions. In some embodiments, one or both of the light-emitting surface 644 and the light-emitting surface 646 may be oriented in a different direction than the light-emitting surface 238.

Lens 650 has a first portion 652 that is generally positioned between the emitter array 230 and the window 216. The first portion 652 of the lens 650 is that portion of the lens 650 that is configured to image the emitter array 230 on the field of illumination. The lens 650 also has a second portion 654 that is generally positioned between the first accompanying emitter 640 and the window 216. This second portion 654 of the lens 650 is that portion of the lens 650 that is configured to direct light emitted from the first accompanying emitter 640 to fill the field of illumination of the emitter array 230. The lens 650 additionally has a third portion 656 that is generally positioned between the second accompanying emitter 642 and the window 216. The third portion 656 of the lens is that portion of the lens 650 that is configured to direct light emitted from the second accompanying emitter 642 to fill the field of illumination of the emitter array 230.

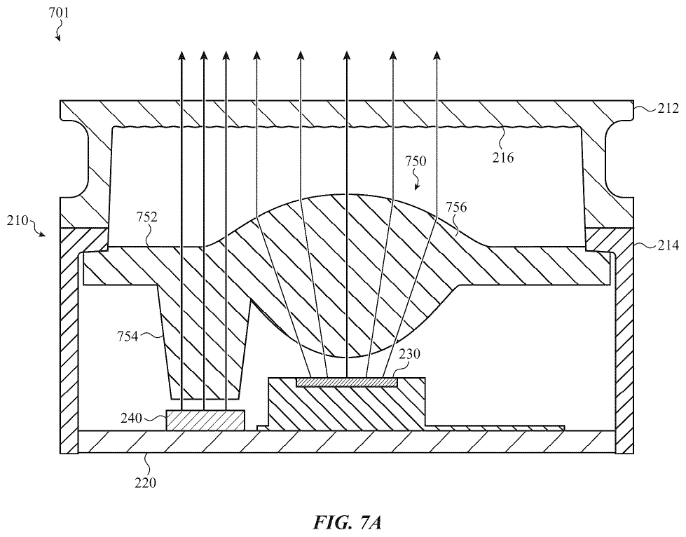

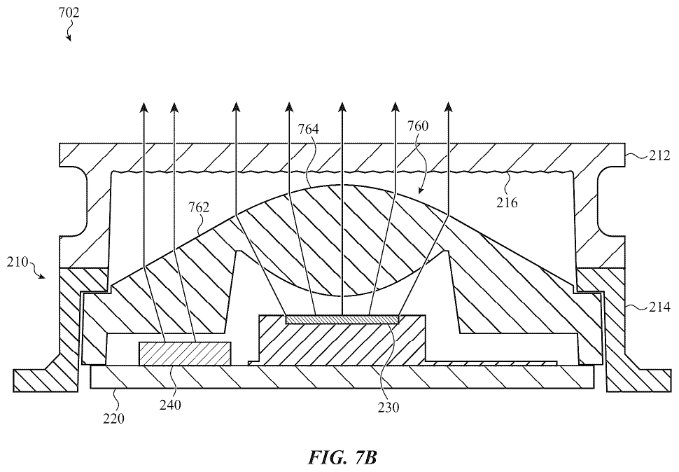

FIG. 7A shows a cross-sectional side view of an example of a light source module 701, as described here. In particular, the light source module 701 includes a lens 750 that includes a light pipe 754. A first portion 756 of the lens 750 may focus, collimate, or otherwise shape light from the emitter array 230.

The second portion 752 includes a light pipe 754 to direct light emitted by the accompanying emitter 240 to be transmitted from the lens 750. The light pipe 754 may be a portion of the lens 750 that is roughly cylindrical (e.g., a round cylinder, rectangular prism, or the like), extending down from the lens 750 toward the light-emitting surface of the accompanying emitter 240. The light pipe 754 may receive emitted light from the accompanying emitter 240, and act as a light pipe to direct the emitted light to be transmitted from the lens 750, including from the second portion 752 of the lens 750.

The use of the light pipe 754 may increase the light transmission by more efficiently directing the light emitted by the accompanying emitter 240 to be transmitted from the lens 750 and, consequently, from the light source module 701.

FIG. 7B shows a cross-sectional side view of an example of a light source module 702, as described here. In particular, the light source module 702 includes a lens 760 having a second portion 762 that is positioned within close proximity to the accompanying emitter 240.

The first portion 764 of the lens 760 may generally have a dual curvature to direct light from the emitter array 230 through the window 216. The second portion 762 of the lens 760 may generally have a single curvature to direct light from the accompanying emitter 240 through the window 216, the surface of the second portion 762 nearest the accompanying emitter 240 roughly parallel with the light-emitting surface of the accompanying emitter 240.

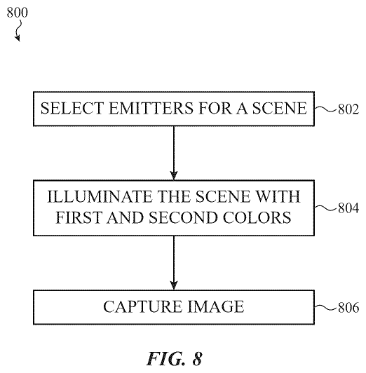

FIG. 8 shows an example method 800 of illuminating a scene, according to certain aspects of the present disclosure. In some cases, one or more aspects of the method 800 may be performed by the device 100, or one or more components thereof, for example a light source module (e.g., light source module 108), an imaging system, a processor (e.g., component processor 136), or a combination of these. In some embodiments, the processor (e.g., component processor 136) may include or be coupled to memory (e.g., memory 138) that may store instructions that, when executed by the processor, cause the processor to perform the operations of the method 800. As the processor performs the operations of the method 800, the processor may also cause the device 100, or one or more components thereof, for example the light source module, to perform or discontinue various operations.

At operation 802, the method 800 includes selecting emitters for a target portion of a field of illumination. In some embodiments, the method 800 includes selecting one or more emitters of a plurality of emitters of an emitter array to use to illuminate a target portion of a field of illumination of the emitter array. The target portion of the field of illumination corresponds to one of the fields of view of a camera. With reference to FIG. 3B, in the case of the first camera of the imaging system being utilized, the first field of view 320 may be within the first portion 310 of the field of illumination 312, such that the target portion of the field of illumination is the first portion 310 of the field of illumination 312. In the case of the second camera of the imaging system being utilized, the second field of view 322 may be within both the first portion 310 and the second portion 316 of the field of illumination 312, such that the target portion of the field of illumination is the field of illumination 312 (including both the first portion 310 and the second portion 316). With reference to FIG. 3D, in the case of the first camera of the imaging system being utilized, the first field of view 340 may be within the first portion 330 of the field of illumination 332, such that the target portion of the field of illumination is the first portion 330 of the field of illumination 332. In the case of the second camera of the imaging system being utilized, the second field of view 344 may be within both the first portion 330 and the second portion 342 of the field of illumination 332, such that the target portion of the field of illumination is the field of illumination 332 (including both the first portion 330 and the second portion 342).

At operation 804, the method 800 includes illuminating a scene with first and second colors. In some embodiments, the method 800 includes simultaneously operating the selected one or more emitters and an accompanying emitter to generate light of a first color and a second color to illuminate the scene.

At operation 806, the method 800 includes capturing an image. In some embodiments, the method 800 includes capturing an image during the illumination. In one or more embodiments, the light of the first color illuminates the target portion of the field of illumination and the light of the second color illuminates the field of illumination.

In some embodiments, the target portion of the field of illumination corresponds to a first field of view of a first camera of an imaging system, where the target portion of the field of illumination is wider than a second field of view corresponding to a second camera of the imaging system.

In some embodiments, the target portion of the field of illumination corresponds to a first field of view of a first camera of an imaging system, where the target portion of the field of illumination is narrower than a second field of view corresponding to a second camera of the imaging system.

In some embodiments, each emitter of the plurality of emitters is operable to illuminate a different portion of the field of illumination. In some embodiments, simultaneously operating the selected one or more emitters and the accompanying emitter includes operating at least one central emitter that fills a first portion of the field of illumination. In some embodiments, simultaneously operating the selected one or more emitters and the accompanying emitter includes operating a plurality of peripheral emitters that surround at least one central emitter and that fills a second portion of the field of illumination.

In some embodiments, the emitter array has a first light-emitting surface, and the accompanying emitter has a second light-emitting surface oriented in a same direction as the first light-emitting surface. In some embodiments, the emitter array has a first light-emitting surface, and the accompanying emitter has a second light-emitting surface oriented to face away from the emitter array. In some embodiments, the emitter array has a first light-emitting surface, and the accompanying emitter has a second light-emitting surface oriented to face toward the emitter array.

In some embodiments, the accompanying emitter is a first accompanying emitter, and simultaneously operating the selected one or more emitters and the accompanying emitter further includes operating a second accompanying emitter configured to generate light of the second color or a third color different from the second color.

The method 800 may be variously embodied, extended, or adapted, as described in the following paragraphs and elsewhere in this description.

Embodiments contemplated herein include one or more non-transitory computer-readable media storing instructions to cause an electronic device, upon execution of the instructions by one or more processors of the electronic device, to perform one or more elements of the method 800. In the context of the method 800, this non-transitory computer-readable media may be, for example, a memory (e.g., a memory 138, as described herein) of a device 100.

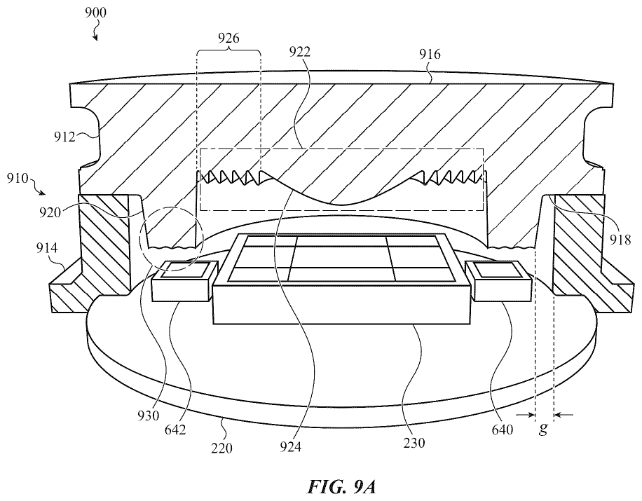

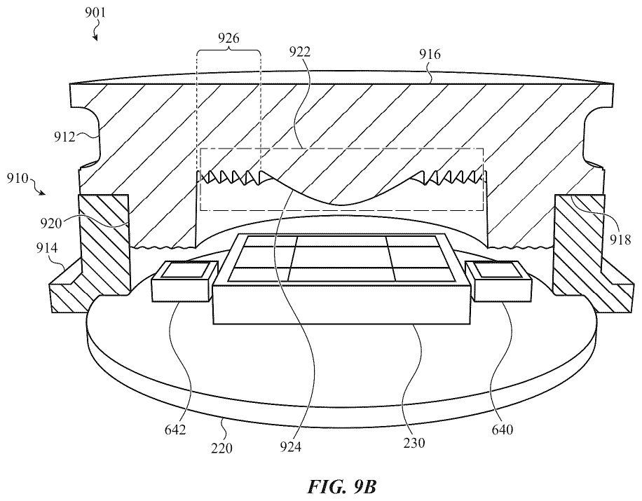

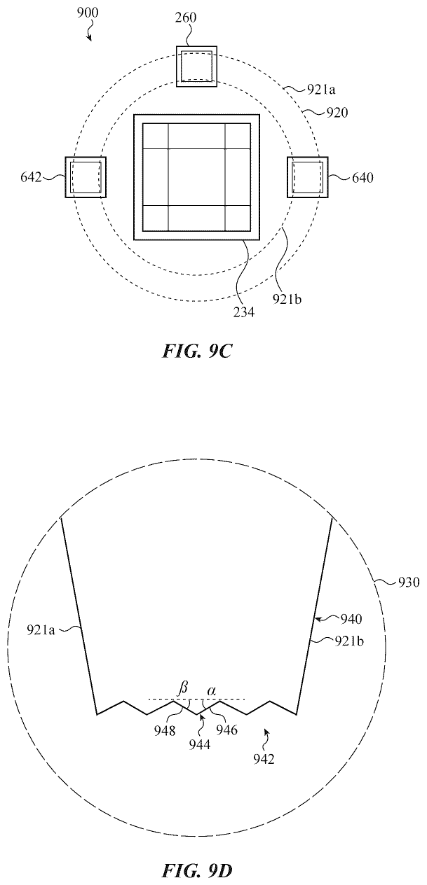

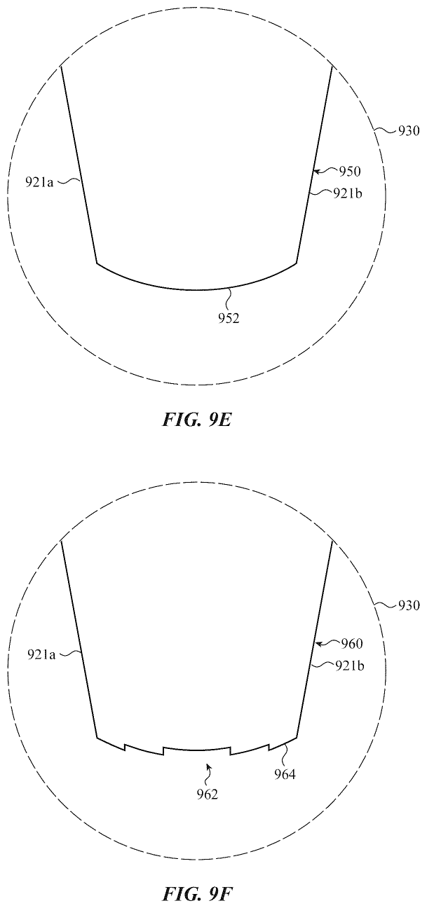

While the examples of the light source modules described herein with respect to FIGS. 2A, 2B, and 4A-7B are shown as including a lens (e.g., lens 250, lens 450, lens 550, lens 650, lens 750, and lens 760) that is positioned between the emitter array and a window of a housing, it should be appreciated that in in some variations the light source modules described herein may include one or more optical structures that are integrated into a rear surface of the window, and that may act to shape light that passes through the window. For example, FIG. 9A shows a partial cross-sectional side view of a variation of a light source module 900 as described herein. Specifically, the light source module 900 may include a housing that has a window 916 through which light generated by the light source module 900 may be emitted to illuminate a scene.

In some variations, the light source module 900 may include a cap 910 that includes the window 916. The cap 910 may be configured in any manner as described herein with respect to the cap 210 of the light source module 200 of FIG. 2A. For example, variation of the cap 910 shown in FIG. 9A may include both a transparent portion 912 (which includes the window 916) and a non-transparent portion 914, each of which may be configured as described herein with respect to the cap 210 of the light source module 200 of FIG. 2A. Also shown in FIG. 9A is a substrate 220 (which may define a corresponding portion of the housing of the light source module 900), an emitter array 230, a first accompanying emitter 640, and a second accompanying emitter 642, each of which may be configured in any manner as described herein with respect to FIGS. 2A-7B. While two accompanying emitters are shown in FIG. 9A, it should be appreciated that in other instances the light source module 900 may include a single accompanying emitter (e.g., accompanying emitter 240), or three or more accompanying emitters.

The window 916 may include a rear surface 918, which is internal to the housing of the light source module 900, and that is configured to define a set of optical structures 922 that is positioned at least partially over the emitter array 230. For example, the set of optical structures 922 may include a lens 924 positioned at least partially over the emitter array 230. The lens 924 may be configured to image a corresponding portion of the emitter array 230 onto a field of illumination of the light source module 900 (e.g., such as described herein with respect to the first portion 252 of the lens 250 of FIG. 2A).

In some of these variations, the set of optical structures 922 further includes a set of Fresnel rings 926 surrounding the lens 924. The set of Fresnel rings 926 include one or more concentric rings, each of which defines a corresponding portion of a lens. For example, each Fresnel ring 926 may include a corresponding curved surface that defines the corresponding portion of a lens. In these instances, the lens 924 and the set of Fresnel rings 926 may collectively act as a Fresnel lens (e.g., with the lens 924 acting as a central lens element of the Fresnel lens) that may be configured to image the emitter array 230 onto a field of illumination of the light source module 900. In these instances, the use of Fresnel rings 926 may allow the set of optical structures 922 to act as a lens with a reduced overall height for a given cross-sectional area.

In the variation shown in FIG. 9A, the rear surface 918 of the window 916 further defines a light guide 920 that is positioned at least partially over the first accompanying emitter 640. By positioning the light guide 920 at least partially over the first accompanying emitter, the light guide 920 may act to collect, shape and distribute light from the first accompanying emitter 640 as it illuminates the field of view of the illumination of the light source module 900. In some instances, it may be desirable to position a bottom surface of the light guide 920 to be relatively close to the first accompanying emitter 640 to increase the relative amount of light it collects from the first accompanying emitter 640. For example, in the variation shown in FIG. 9A, the light guide 920 may be separated from the first accompanying emitter 640 (e.g., along a vertical axis of the light source module 900) by a first distance and the set of optical structures 922 may be separated from the emitter array 230 (e.g., along the vertical axis of the light source module 900) by a second distance that is greater than the first distance.

In some instances, to facilitate placement of a bottom surface of the light guide 920 in relatively close proximity to the first accompanying emitter 640, a portion of the light guide 920 may be coplanar with a corresponding portion of the non-transparent portion 914 of the cap 910. In some of these variations, such as shown in FIG. 9A, the light guide 920 may be configured such that there is a gap g between an outer sidewall of the light guide 920 and an inner sidewall of the non-transparent portion 914 of the cap. FIG. 9B shows another variation of a light source module 901, which may be configured and labeled the same as the light source module 900 of FIG. 9A except that the light guide 920 is configured such that the outer sidewall of the light guide 920 contacts the inner sidewall of the non-transparent portion 914 of the cap 910. Accordingly, in these variations the coplanar portions of the light guide 920 and the non-transparent portion 914 may be in contact with each other.

The light guide 920 may at least partially surround the set of optical structures 922. For example, in the variation shown in FIG. 9A, the light guide 920 fully surrounds the set of optical structures 922 such that the light guide 920 encircles the set of optical structures 922. In some variations where the light source module 900 includes the second accompanying emitter 642, the light guide 920 may also be positioned at least partially over the second accompanying emitter 642. In other variations, the light guide 920 may be replaced by a plurality of light guides (each defined in the rear surface 918 of the window 916), such as a first light guide that is positioned at least partially over the first accompanying emitter 640 and a second light guide that is positioned at least partially over the second accompanying emitter 642. In these instances, the set of optical structures 922 may be positioned between the first and second light guides, and the first and second light guide may thereby collectively surround at least a portion of the set of optical structures 922.

In some variations, the light source module 900 may include a light sensor 260, such as described herein with respect to the light source module 200 of FIGS. 2A and 2B. In some of these variations, a light guide (e.g., light guide 920) may also be positioned at least partially over the light sensor 260. For example, FIG. 9C shows a top view of a portion of the light source module 900 including the emitter array 230, the first accompanying emitter 640, the second accompanying emitter 642, and the light sensor 260. Also shown there is the light guide 920 (represented by dashed lines corresponding to an outer sidewall 921a and an inner sidewall 921b of the light guide 920), which is positioned at least partially over each of the first accompanying emitter 640, the second accompanying emitter 642, and the light sensor 260. In this way, the same light guide 920 may be used to route light from the accompanying emitter(s) (e.g., the first accompanying emitter 640 and the second accompanying emitter 642) to exit the window 916, and may also be used to route light received through the window 916 to the light sensor 260. Additionally, in the variation shown in FIG. 9C, the light guide 920 may be sized such that it is not positioned over the light-emitting surface of the emitter array 230 (e.g., the inner sidewall 921b of the light guide 920 may have a diameter that is larger than the footprint of the light-emitting surface emitter array 230). This may reduce the relative amount of light generated by the emitter array 230, during operation of the light source module 900, that is incident on the light guide 920 (and thereby may increase the relative amount of light from the emitter array 230 that is incident on the set of optical structures 922).

The light guide 920 may be configured such that a portion (e.g., a first portion) of a bottom surface of the light guide 920 (e.g., that connects the outer sidewall 921a to the inner sidewall 921b) is positioned to face the first accompanying emitter 640, such that the bottom surface acts a light-receiving surface to collect light emitted by the first accompanying emitter 640. In instances where the light guide 920 is also positioned at least partially over the second accompanying emitter 642, a corresponding portion (e.g., a second portion) of the bottom surface of the light guide 920 may face the second accompanying emitter 642 and act as a light-receiving surface to collect light emitted by the second accompanying emitter 642. Similarly, in instances where the light guide 920 is positioned at least partially over the light sensor 620, a corresponding portion (e.g., a third portion) of the bottom surface may face the light sensor 620 and act as a light-emitting surface to direct light toward the light sensor 620.

The bottom surface of the light guide 920 may be configured in any suitable manner. For example, in some variations at least a portion of the bottom surface of the light guide 920 is flat. In some of these variations, a portion of the bottom surface of the light guide 920 that is positioned at least partially over the first accompanying emitter 640 may be parallel to a light-emitting surface of the first accompanying emitter 640 (such as in instances where the light-emitting surface of the first accompanying emitter 640 is oriented in a same direction as a corresponding light-emitting surface of the emitter array 230, such as along a vertical axis of the light source module 900). Similarly, a corresponding portion of the bottom surface of the light guide 920 may positioned over the second accompanying emitter 642 may be parallel to a light-emitting surface of the second accompanying emitter 642 and/or a corresponding portion of the bottom surface of the light guide 920 may positioned over the second accompanying emitter 642 may be parallel to a light-receiving surface of the light sensor 260. In these variations, the bottom surface of the light guide 920 may be perpendicular to a vertical axis of the light source module 900.

In other variations, a portion of the bottom surface of the light guide 920 that is positioned at least partially over the first accompanying emitter 640 may be angled relative to (e.g., non-parallel to) a light-emitting surface of the first accompanying emitter 640. For example, when the light-emitting surface of the first accompanying emitter 640 is not aligned with a vertical axis of the light source module 900 (e.g., when the light-emitting surface of the first accompanying emitter 640 is orientated toward or away from the emitter array 230), the bottom surface of the light guide 920 may be angled to facilitate collection of light emitted by the first accompanying emitter 640. In these instances, it may be desirable to angle the bottom surface of the light guide 920 such that is not perpendicular to the vertical axis of the light source module 900.

In some variations, the bottom surface of the light guide 920 may be configured to include one or more optical structures. For example, FIGS. 9D-9F show variations of light guides that may be used with the light source modules of FIGS. 9A and 9B. Specifically, each of these figures show a corresponding light guide positioned within region 930 of FIG. 9A. FIG. 9D shows one variation of a light guide 940 that includes a bottom surface 942 connecting an outer sidewall 921a to an inner sidewall 921b In the variation shown in FIG. 9D, at least a portion of the bottom surface 942 that is configured as a prismatic surface having a plurality of concentric prisms (only one prism 944 is labeled for ease of illustration). Each concentric prism is positioned to at least partially encircle a common center point, and includes an inner face (e.g., inner face 946 of prism 944) that is angled toward the center point (e.g., at a first angle a) and an outer face (e.g., outer face 948 of prism 944) that is angled away from the center point (e.g., at a second angle B). In some instances, the concentric prisms may run along the entire circumference of the bottom surface 942. In other variations, the concentric prisms may be positioned along select subregions of the bottom surface 942 (e.g., the corresponding portions of the bottom surface 942 that are positioned at least partially above the first accompanying emitter 640, the second accompanying emitter 642, and/or the light sensor 260).

The plurality of concentric prisms may act to shape or distort light passing through the bottom surface 942, and may act to obscure visibility of components positioned beneath the light guide 940. The prisms of the bottom surface 942 may be symmetric (i.e., such that the first angle a is the same as the second angle B), but it should be appreciated that one or more of the prisms may be asymmetric such that the first angle a of a given prism is different than (e.g., greater than or less than) the second angle B. Additionally or alternatively, the angle a of the inner face or the angle B of the outer face of a prism may vary radially, such that these angles measured for the prism at one cross-section of the light guide 940 may be different than these angles measured for the same prism at a different cross-section of the prismatic surface 402. Additionally or alternatively, different prisms of the bottom surface 942 may have different prism angles (e.g., the angle of the inner face of a first prism may be different than a corresponding angle of the inner face of a second prism and/or the angle of the outer face of the first prism may be the different than a corresponding angle of the outer face of the second prism). Collectively, the plurality of prisms may control the distortion of light passing through the bottom surface 942, and thus the angles of the prism faces may be locally selected to achieve different distortion profiles at different portions of the bottom surface 942.

FIG. 9E shows another variation of a light guide 950 that includes a bottom surface 952 connecting an outer sidewall 921a to an inner sidewall 921b. In the variation shown in FIG. 9E, at least a portion of the bottom surface 952 is curved to define a lens. When a curved portion of the bottom surface 952 is positioned at least partially over the first accompanying emitter 640, the bottom surface 952 may be configured focus, collimate, or otherwise shape light from the first accompanying emitter 640 that is incident on the bottom surface 952. It should be appreciated that the curvature may of the bottom surface 952 may vary along a circumference of the bottom surface 952 such that different regions of the bottom surface 952 have different optical properties. For example, in some instances it may be desirable to configure the bottom surface 952 differently in regions positioned over the first accompanying emitter 640 and/or the second accompanying emitter 642 as compared to regions positioned over the light sensor 260.

FIG. 9F shows yet another variation of a light guide 960 that includes a bottom surface 962 connecting an outer sidewall 921a to an inner sidewall 921b. In the variation shown in FIG. 9E, the bottom surface 962 is configured to include a plurality of concentric Fresnel rings 964. In these instances, the concentric Fresnel rings 964 may be configured to act as a Fresnel lens that extends at least partially around the circumference of the bottom surface 962, and may act to be configured focus, collimate, or otherwise shape light passing through the bottom surface 962. The concentric Fresnel rings 964 may collectively be configured to have the same optical properties as the curved bottom surface 952 of the light guide 950 of FIG. 9E, but with a reduced height. Similarly, it should be appreciated that the concentric Fresnel rings 964 may vary along a circumference of the bottom surface 962 such that different regions of the bottom surface 962 have different optical properties.

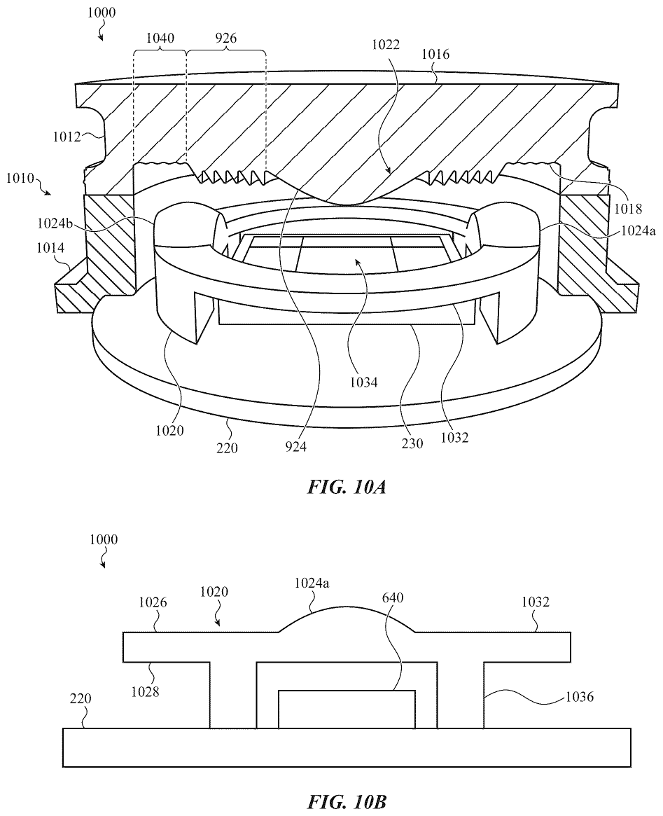

In some variations of the light source modules described herein, the light source module may include one or more optical structures that are integrated into a rear surface of the window and may further include one or more optical components positioned between an accompanying emitter and the window. For example, FIG. 10A shows a partial cross-sectional side view of a variation of a light source module 1000 as described herein. Specifically, the light source module 1000 may include a housing that has a window 1016 through which light generated by the light source module 1000 may be emitted to illuminate a scene.

In some variations, the light source module 1000 may include a cap 1010 that includes the window 1016. The cap 1010 may be configured in any manner as described herein with respect to the cap 210 of the light source module 200 of FIG. 2A. For example, variation of the cap 1010 shown in FIG. 10A may include both a transparent portion 1012 (which includes the window 1016) and a non-transparent portion 1014, each of which may be configured as described herein with respect to the cap 210 of the light source module 200 of FIG. 2A. Also shown in FIG. 10A is a substrate 220 (which may define a corresponding portion of the housing of the light source module 1000), an emitter array 230, a first accompanying emitter 640, and a second accompanying emitter 642, which may be configured in any manner as described herein with respect to FIGS. 2A-7B. While two accompanying emitters are shown in FIG. 10A, it should be appreciated that in other instances the light source module 1000 may include a single accompanying emitter (e.g., accompanying emitter 240), or three or more accompanying emitters.

The window 1016 may include a rear surface 1018, which is internal to the housing of the light source module 1000, and that is configured to define a set of optical structures 1022 that is positioned at least partially over the emitter array 230. For example, in the variation of the light source module 1000 of FIG. 10A, the set of optical structures 1022 includes a lens 924 and a set of Fresnel rings 926 surrounding the lens 924, such as described herein with respect to the light source module 900 of FIG. 9A (though in some variations, the set of optical structures 1022 may include the lens 924 but not the set of Fresnel rings 926). In the variation shown in FIG. 10A, the set of optical structures 1022 further includes a set of concentric prisms 1040. In these variations, the set of concentric prisms 1040 may surround the lens 924 and, in variations that include the set of Fresnel rings 926, may also surround the set of Fresnel rings 926. In these variations, the set of concentric prisms 1040 may be configured in any manner as described herein with respect to the concentric prisms of FIG. 9D. Specifically, each concentric prism is positioned to at least partially encircle a common center point (e.g., which may intersect with the lens 924), and includes a corresponding inner face that is angled toward the center point (e.g., at a first angle) and an outer face that is angled away from the center point (e.g., at a second angle).

The light source module 1000 further includes an optical component 1020 that is positioned at least partially between the first accompanying emitter 640 and the window 1016. In the variation shown in FIG. 10A, the optical component 1020 includes an annular light guide 1032. FIG. 10B shows a partial side view of the light source module 1000, including the substrate 220, the first accompanying emitter 640, and the optical component 1020. As shown, the annular light guide 1032, which may be formed from a transparent or translucent material (e.g., transparent or translucent to at least the second color of light emitted by the first accompanying emitter 640), includes a top surface 1026 and a bottom surface 1028 that face in opposite directions. Specifically, the top surface 1026 may face the window 1016 (e.g., may face the rear surface 1018 of the window 1016), and the bottom surface 1028 may face away from the window 1016 (e.g., may face toward the substrate 220).

The optical component 1020 may be positioned within the housing of the light source module 1000 such that the bottom surface 1028 is at least partially positioned over the first accompanying emitter 640. Accordingly, the optical component 1020 may configured such that light emitted by the first accompanying emitter 640 is incident upon the bottom surface 1028 of the annular light guide 1032 and may thereby enter the annular light guide 1032. As light received from the first accompanying emitter 640 is incident on the top surface 1026, some this light may exit the annular light guide 1032 via the top surface 1026. Additionally, the annular light guide 1032 may distribute some of this light around at least a portion of the circumference of the annular light guide 1032 (e.g., via internal reflection) before it is emitted from the top surface 1026. In this way, although the annular light guide 1032 may receive light at a relatively small portion of its bottom surface 1028, the annular light guide 1032 may emit light from a relatively larger portion of its top surface. In some variations, the optical component 1020 may include a reflective layer that is deposited on or otherwise connected to a corresponding portion (or portions) of the bottom surface 1028. In these instances, the reflective layer may act to redirect light that is incident on the corresponding portion(s) of the bottom surface 1028. This may reduce the amount of light (e.g., received from the first accompanying emitter 640) that is emitted from the bottom surface 1028, and may thereby promote the emission of light through the top surface 1026 of the annular light guide 1032.

In some variations where the light source module 1000 also includes the second accompanying emitter 642, the optical component 1020 may also be positioned at least partially above the second accompanying emitter 642 (e.g., may be positioned at least partially between the second accompanying emitter 642) and the window 1016. In these instances, a second portion of the bottom surface 1028 of the annular light guide 1032 may be positioned over the second accompanying emitter 642, such that light emitted by the second accompanying emitter 642 enters the annular light guide 1032 via the bottom surface 1028. As with light from the first accompanying emitter 640, light received form the second accompanying emitter 642 may be emitted from the top surface 1026.

In this way, the annular light guide 1032 may act as a light emitter to distribute and direct light received from the first accompanying emitter 640 and/or the second accompanying emitter 642 toward the window 1016. The annular light guide 1032 may define an aperture 1034 extending therethrough, and may be positioned such that some or all of the light of the first color emitted by the emitter array 230 passes through the aperture 1034 to reach the window 1016. The annular light guide 1032 may be sized such that the aperture 1034 is larger than the light-emitting surface of the emitter array 230. In this way, the annular light guide 1032 may encircle the emitter array 230 (even if positioned in a different plane than the light-emitting surface of the emitter array 230) such that it doesn't cover (or covers a relatively small percentage of) the light-emitting surface of the emitter array 230.

In some variations, the optical component 1020 may be configured to define a set of lenses 1024a-1024b, each of which is positioned at least partially over a corresponding accompanying emitter of the light source module 1000. For example, the optical component may include a first lens 1024a that is positioned at least partially over the first accompanying emitter 640. Specifically, a portion of the top surface 1026 of the annular light guide 1032 and/or a portion of the bottom surface 1028 of the annular light guide 1032 may be curved to define the first lens 1024a (e.g., the first lens 1024a in FIG. 10B is shown as a plano convex lens where a corresponding portion of the bottom surface 1028 is flat and a corresponding portion of the top surface is convex). The first lens 1024a may be configured as any suitable lens, such as a bi-convex lens, a bi-concave lens, a plano concave lens, a cylindrical lens, or the like. Similarly, the first lens 1024a may be configured as a spherical lens, an aspherical lens, a cylindrical lens, or the like.

Because a relatively high percentage of light received from the first accompanying emitter 640 will exit the top surface 1026 in close proximity to the first accompanying emitter 640, the first lens 1024a may focus, collimate, or otherwise shape this light as it exits the top surface 1026. The size and optical properties of the first lens 1024a may be selected to facilitate a particular distribution of light from the first accompanying emitter 640 as it reaches the window 1016 (and is thereby emitted to the field of illumination of the light source module). Similarly, in variations where the light source module 1000 also includes the second accompanying emitter 642, the optical component 1020 may also include a second lens 1024b that is positioned at least partially over the second accompanying emitter 642. The second lens 1024b may be configured to facilitate a particular distribution of light from the second accompanying emitter 642 as it reaches the window 1016 (and is thereby emitted to the field of illumination of the light source module), such as described herein with respect to the first lens 1024a.

The optical component 1020 may be mounted within the housing of the light source module 1000 in any suitable manner. For example, in the variation shown in FIGS. 10A and 10B, the optical component 1020 may be connected to the substrate via a set of posts 1036. The posts 1036 may be formed together with the annular light guide 1032 (e.g., such that the annular light guide and set of posts 1036 may be formed as a unitary piece of a common material) or may be formed separately from and attached to the annular light guide 1032. In other variations, the optical component 1020 may be connected to the cap 1010, such that the optical component 1020 is suspended over the substrate 220.

Although not shown, in FIGS. 10A and 10B, the light source module 1000 may include a light sensor (e.g., light sensor 260) as described in more detail herein. In some variations, the light sensor may be positioned at least partially under the optical component 1020. For example, the optical component 1020 may be positioned such that a corresponding portion of the bottom surface 1028 of the annular light guide 1032 is positioned at least partially over the light sensor. In these instances, the light source module 1000 may be configured such that at least some of the light measured by the light sensor is received from the annular light guide 1032 (e.g., enters the annular light guide 1032 through the top surface 1026 and exits through the bottom surface 1028 before reaching the light sensor). This may allow the light sensor to collect and measure light from a wider spatial extent via the annular light guide 1032. In some of these variations, the optical component 1020 may include one or more additional lenses (e.g., formed in the top surface 1026 and/or the bottom surface 1028 of the light guide 1032) that are positioned at least partially over the light sensor, and may help to facilitate collection of light by the light sensor.

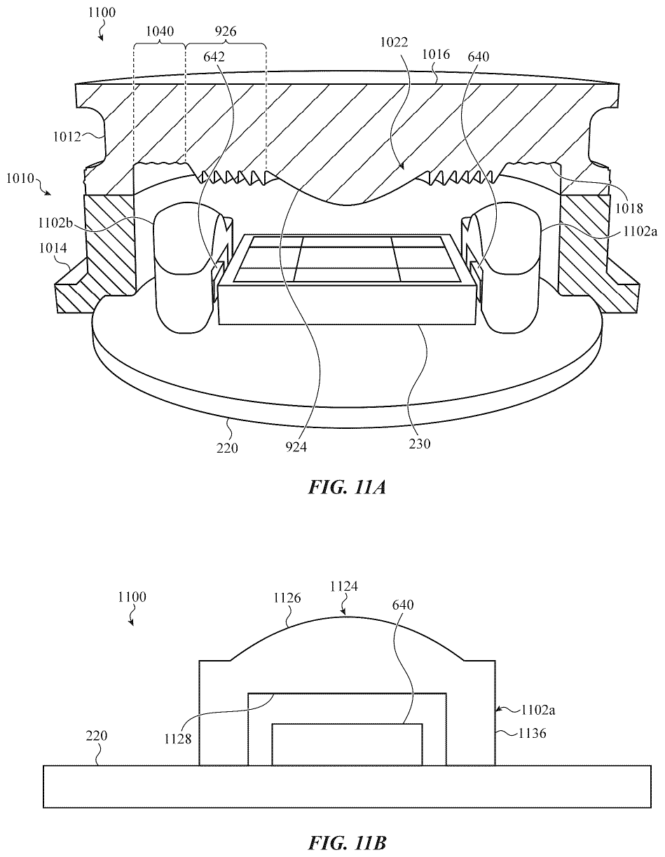

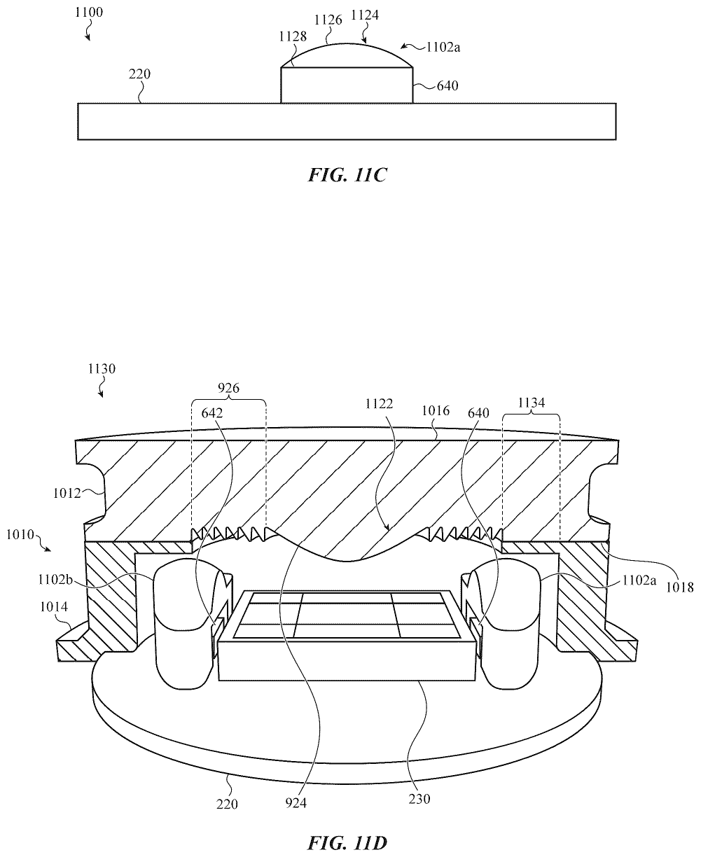

In some variations of the light source assemblies described herein, a light source assembly may include multiple optical components, each of which is positioned between a corresponding accompanying emitter and the window. For example, FIG. 11A shows a partial cross-sectional side view of a variation of a light source module 1100 as described herein. Specifically, the light source module 1100 is configured and labeled the same as the light source module 1000 of FIG. 10A, except that the optical component 1020 has been replaced by a plurality of optical components 1102a-1102b. Specifically, the plurality of optical components 1102a includes a first optical component 1102a positioned at least partially over the first accompanying emitter 640 and a second optical component 1102b positioned at least partially over the second accompanying emitter 642. Each of the optical components 1102a-1102b may be configured to alter the distribution of light emitted by its corresponding accompanying emitter. The optical components 1102a-1102b may not be positioned over the light-emitting surface of the emitter array 230, such that the optical components 1102a-1120b do not meaningfully alter light emitted by the emitter array 230.

FIGS. 11B and 11C show partial side views of the light source module 1100 of FIG. 11A that include different configurations of the first optical component 1102a. In the variation shown in FIG. 11B, the first optical component 1102a is configured to include a lens 1124 that is suspended above the first accompanying emitter 640. Specifically, the lens 1124 may include a top surface 1126 and a bottom surface 1128 that face in opposite directions. The bottom surface 1128 may be positioned at least partially over the first accompanying emitter 640 and may be separated from the first accompanying emitter 640 by a gap. Specifically, the bottom surface 1128 of the lens 1124 may face a light-emitting surface of the first accompanying emitter 640 such that light emitted from the first accompanying emitter 640 may enter the lens 1124 through the bottom surface 1128 and may exit the lens 1124 through the top surface 1126. One or both of the top surface 1126 and the bottom surface 1128 may be curved to define the optical properties of the lens 1124. While the lens 1124 is shown in FIG. 11B as being plano-convex lens (e.g., with a flat bottom surface 1128 and a convex top surface 1126) the lens 1124 may be configured as a bi-convex lens, a bi-concave lens, a plano concave lens, or the like. Additionally, the lens 1124 may be configured as a spherical lens, an aspherical lens, a cylindrical lens, or the like. The lens 1124 may be suspended above the first accompanying emitter 640 in any suitable manner. For example, in the variation shown in FIG. 11B, the lens 1124 may be connect to the substrate 220 via a set of posts 1136. The posts 1136 may be formed together with the lens 1124 (e.g., such that the lens 1125 and set of posts 1036 may be formed as a unitary piece of a common material) or may be formed separately from and attached to the annular light guide 1032. In variations where the light source module includes a second accompanying emitter 642, the second optical component 1102b may similarly be configured to include a corresponding lens (e.g., having corresponding top and bottom surfaces) that is positioned at least partially above the second accompanying emitter 642.

In the variation shown in FIG. 11C, the first optical component 1102a element may be configured as a lens 1124 that is integrated with the first accompanying emitter 640. In these variations, the lens 1124 may include a top surface 1126 and a bottom surface 1128 as discussed with respect to FIG. 11B, except that the bottom surface 1128 is positioned to contact a light-emitting surface of the first accompanying emitter 640. For example, the lens 1124 may be configured as a plano convex lens in which the bottom surface 1128 of the lens 1124 is flat and the top surface 1126 of the lens 1124 is curved.

The variations of the light source modules shown in FIGS. 10A-11C include optical components that are at least partially positioned underneath a set of optical structures defined in the window. For example, in the variation of the light source module 1000 shown in FIG. 10A, the optical component 1020 is positioned at least partially under a corresponding portion of the set of optical structures 1022 (e.g. a portion of the optical component 1020 may be positioned under one or more of the Fresnel rings 926 and/or a portion of the optical component 1020 may be positioned under one or more of the concentric prisms 1040). Similarly, in the variation of the light source module 1100 shown in FIG. 11A, each of the optical components 1102a-1102b is positioned at least partially under a corresponding portion of the set of optical structures 1022 (e.g. a portion of the first optical component 1102a may be positioned under one or more of the Fresnel rings 926 and/or a portion of first optical component 1102a may be positioned under one or more of the concentric prisms 1040).

Additionally or alternatively, a light source module may include an optical component that is at least partially positioned under a corresponding portion of a non-transparent portion of a cap. For example, FIG. 11D shows a variation of a light source module 1130 that is configured and labeled the same as the light source module 1100 of FIG. 11A, except that the non-transparent portion 1014 of cap 1010 is configured to be positioned at least partially over the set of optical components 1102a-1102b. In this variation, the set of optical structures 1022 has been replaced with a set of optical structures 1122 that includes a lens 924 and a set of Fresnel rings 926 as described in more detail herein, though it should be appreciated that the set of optical structures 1122 may be additionally or alternatively include a set of concentric prisms and/or other optical structures as may be desired.

As shown in FIG. 11D, a region 1134 of the non-transparent portion 1014 is positioned at least partially between the set of optical components 1102a-1102b and the window 1016. For example, in the variation shown in FIG. 11D, the region 1134 may have an annular shape that is positioned in contact the rear surface 1018 of the window 1016 and surrounds the set of optical structures 1122. In these variations, the region 1134 of the non-transparent portion 1014 of the cap 1010 may be formed from a material that is translucent to visible light, such that at least some of the light emitted from the first accompanying emitter 640 and/or the second accompanying emitter 642 may pass through the region 1134 before exiting the light source module 1130 via the window 1016. In these instances, the region 1134 of the non-transparent portion 1104 may act to diffuse light passing therethrough, which may act to change the distribution of light emitted by the first accompanying emitter 640 and/or the second accompanying emitter 642, and/or obscure visibility of components positioned beneath the region 1134. It should be appreciated that the light source module 1000 of FIGS. 10A and 10B may similarly be modified to include a similar region of the of the non-transparent portion 1014 of the cap 1010 that is positioned over at least a portion of the optical component 1020.

In some instances, the light source modules described herein (e.g., any of the light source modules described herein with respect to FIGS. 2A-7B and 9A-11D) may be used to perform a preflash operation. Generally, a preflash operation involves illuminating a scene performed prior to performing an image capture operation with a camera (such as described herein with respect to the method 800 of FIG. 8), and may assist in determining one or more parameters of the image capture operation. For example, in some instances a preflash operation may provide metering information that is used to determine one or more properties of the illumination (e.g., the illumination intensity) that will be provided during the image capture operation. Additionally or alternatively, a camera may perform an autofocus operation during the preflash operation, and a focus setting determined during the preflash operation may be used by the camera during the image capture operation.

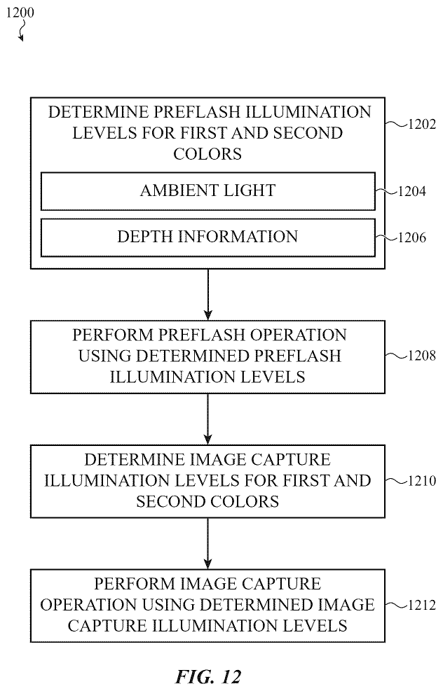

The illumination provided during a preflash operation may, in some instances, cause a subject to react (e.g., blink, flinch, or otherwise move) in a manner that may negatively impact the image(s) captured by the image capture operation. Accordingly, the light source modules described herein may, using illumination provided by the accompanying emitter(s), provide preflash illumination that is less obtrusive to a user. For example, FIG. 12 shows an example method 1200 of illuminating a scene during a preflash operation using a light source module and a camera. In some cases, one or more aspects of the method 1200 may be performed by the device 100, or one or more components thereof, for example a light source module (e.g., light source module 108) and a camera (e.g., first camera 102), an imaging system, a processor (e.g., component processor 136), or a combination of these. In some embodiments, the processor (e.g., component processor 136) may include or be coupled to memory (e.g., memory 138) that may store instructions that, when executed by the processor, cause the processor to perform the operations of the method 1200. As the processor performs the operations of the method 1200, the processor may also cause the device 100, or one or more components thereof, for example the light source module and the camera, to perform or discontinue various operations.

At operation 1202, the method 1200 includes determining corresponding preflash illumination levels for each of the colors that may be generated by the light source module. Specifically, the light source module includes an emitter array that is configured to emit a first color and an accompanying emitter that is configured to emit a second color. In some variations, the light source module may include an additional accompanying emitter that is configured to emit the second color or a third color. Accordingly, at operation 1202, the method 1200 includes determining preflash illumination levels for each of the first and second colors (and, in instances where a second accompanying emitter is configured to generate a third color, a preflash illumination level for the third color). Accordingly, the preflash illumination levels may be selected to provide a certain overall illumination color and brightness during the preflash operation.

In some instances, it may be desirable to use different preflash illumination levels of the first and second colors (and, in some variations, the third color) under different circumstances. For example, white light may be more obtrusive in darker settings and/or when a subject is closer to the camera. Accordingly, a light source module may prioritize pre-flash illumination using the second color (e.g., red light) in these instances.

In some variations, operation 1202 may comprise determining ambient light information 1204 corresponding to a scene that will be illuminated by the light source module during a preflash operation. For example, in variations where the light source module includes a light sensor (e.g., light sensor 260), the ambient light information 1204 may be based at least in part on one or more measurements performed by the light sensor. Additionally or alternatively, the camera may capture one or more image frames prior to the preflash operation, and these image frames may be analyzed to determine brightness levels of one or more portions of the scene. In other words, the ambient light information 1204 may be based at least in part on one or more brightness levels determined from a set of image frames.

In these variations, the operation 1202 may include determining the preflash illumination levels using the determined ambient light information 1204. For example, the light source module may prioritize illumination from the accompanying emitter(s) for lower levels of ambient light. Indeed, if the scene is sufficiently dark, the light source module may only use illumination from one or more accompanying emitters (e.g., only the second color or, in variations where a second accompanying emitter emits a third color, only the second and/or third colors). In these instances, the light source module may not emit the first color during the preflash operation.

Conversely, the light source module may prioritize the first color in situations with higher ambient light levels. In these instances, the first color may not be as obtrusive for the subjects being imaged, and may allow for brighter illumination during the preflash operation. Accordingly, in some variations, the first color may have a relatively higher preflash illumination level when the ambient light information indicates a higher relative scene brightness and a relatively lower preflash illumination level when the ambient light information indicates a lower relative scene brightness. Similarly, the second color may have a relatively lower preflash illumination level when the ambient light information indicates a higher relative scene brightness and a relatively higher preflash illumination level when the ambient light information indicates a lower relative scene brightness.

Additionally or alternatively, the operation 1202 may comprise determining depth information 1206 corresponding to a scene that will be illuminated by the light source module during a preflash operation. For example, in variations where the light source module includes a depth sensor (e.g., depth sensor 110), the depth information 1206 may be based at least in part on depth information generated by the depth sensor. In these variations, the operation 1202 may include determining the preflash illumination levels using the determined depth information 1206. For example, the light source module may prioritize illumination from the accompanying emitter(s) when the depth information indicates that a subject is positioned in relatively close proximity to the light source module. Indeed, if a subject is sufficiently close, the light source module may only use illumination from one or more accompanying emitters (e.g., only the second color or, in variations where a second accompanying emitter emits a third color, only the second and/or third colors). In these instances, the light source module may not emit the first color during the preflash operation.

Conversely, the light source module may prioritize the first color in situations where a subject is positioned further away from the light source module. In these instances, the first color may not be as obtrusive for the subject, and may allow for brighter illumination of the subject during the preflash operation. Accordingly, in some variations, the first color may have a relatively higher preflash illumination level when the depth information indicates a relatively distant subject and a relatively lower preflash illumination level when the depth information indicates a relatively closer subject. Similarly, the second color may have a relatively lower preflash illumination level when the depth information indicates a relatively distant subject and a relatively higher preflash illumination level when the ambient light information indicates a relatively closer subject.

At operation 1208, the method 1200 may include performing a preflash operation using the determined preflash illumination levels. Specifically, during the preflash operation level the light source module is operated to illuminate the scene using the determined preflash illumination levels for each color. In this way, the scene is illuminated with the different relative illumination levels determined at operation 1206. During operation 1208, the camera may capture one or more image frames while the scene is illuminated using the determined preflash illumination levels, which may be analyzed to provide metering information for a subsequent image capture operation. Additionally or alternatively, during operation 1208, the camera may perform an autofocus operation to determine a focus setting for a subsequent image capture operation.

At operation 1210, the method 1200 may include determining image illumination levels for the colors for each of the colors that may be generated by the light source module. Specifically, at operation 1202, the method 1200 includes determining image capture illumination levels for each of the first and second colors (and, in instances where a second accompanying emitter is configured to generate a third color, an image capture illumination level for the third color). In some instances, these image illumination levels may be determined at least in part based on metering information generated during the preflash operation at 1208. Additionally, the image capture illumination levels may be determined in any manner as described herein with respect to the method 800 of FIG. 8. At operation 1212, the method 1200 includes performing an image capture operation using the determined image capture illumination levels. Specifically, the camera may capture an image of the scene while the light source module illuminates the scene using the determined image capture illumination levels.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

1. A light source module, comprising:
a housing comprising a window;
an emitter array comprising a plurality of emitters, each of which is configured to emit light having a first color through the window;
an accompanying emitter configured to emit light having a second color through the window; and
a lens comprising:
a first portion positioned between the emitter array and the window, wherein the first portion is configured to image the emitter array onto a field of illumination; and
a second portion positioned between the accompanying emitter and the window, wherein the lens is configured to direct the light emitted by the accompanying emitter to fill the field of illumination.

2. The light source module of claim 1, wherein each emitter of the plurality of emitters is operable to illuminate a different portion of the field of illumination.

3. The light source module of claim 1, wherein the plurality of emitters comprises:
at least one central emitter that fills a first portion of the field of illumination; and
a plurality of peripheral emitters that surround the at least one central emitter and that fills a second portion of the field of illumination.

4. The light source module of claim 1, wherein:
the emitter array has a first light-emitting surface; and
the accompanying emitter has a second light-emitting surface oriented in a same direction as the first light-emitting surface.

5. The light source module of claim 1, further comprising:
the emitter array has a first light-emitting surface; and
the accompanying emitter has a second light-emitting surface oriented to face away from the emitter array.

6. The light source module of claim 1, further comprising:
the emitter array has a first light-emitting surface; and
the accompanying emitter has a second light-emitting surface oriented to face toward the emitter array.

7-20. (canceled)

21. A light source module, comprising:
a housing comprising a window;
an emitter array comprising a plurality of emitters, each of which is configured to emit light having a first color through the window; and
an accompanying emitter configured to emit light having a second color through the window, wherein:
a rear surface of the window defines a set of optical structures positioned at least partially over the emitter array.

22. The light source module of claim 21, wherein:
the set of optical structures comprises a lens positioned at least partially over the emitter array.

23. The light source module of claim 22, wherein:
the set of optical structures comprises a set of Fresnel rings surrounding the lens.

24. The light source module of claim 23, wherein:
the set of optical structures comprises a set of concentric prisms surrounding the set of Fresnel rings.

25. The light source module of claim 21, wherein:
the rear surface of the window defines a light guide positioned at least partially over the accompanying emitter and at least partially surrounding the set of optical structures.

26. The light source module of claim 25, wherein:
the light guide encircles the set of optical structures.

27. The light source module of claim 25, wherein:
the accompanying emitter is a first accompanying emitter;
the light source module further comprises a second accompanying emitter configured to emit light through the window; and
the light guide is positioned at least partially over the second accompanying emitter.

28. The light source module of claim 25, comprising:
a light sensor, wherein the light guide is positioned at least partially over the light sensor.

29. The light source module of claim 25, wherein:
a bottom surface of the light guide is configured as a prismatic surface having a plurality of concentric prisms.

30. The light source module of claim 21, comprising:
an optical component positioned at least partially between the accompanying emitter and the window, wherein the optical component is positioned at least partially over the accompanying emitter.

31. The light source module of claim 30, wherein:
the accompanying emitter is a first accompanying emitter;
the light source module further comprises a second accompanying emitter configured to emit light through the window; and
the optical component is positioned at least partially over the second accompanying emitter.

32. The light source module of claim 30, wherein:
the optical component comprises an annular light guide.

33. The light source module of claim 30, wherein:
wherein the optical component defines a lens positioned at least partially over the accompanying emitter.

34. The light source module of claim 30, wherein:
the accompanying emitter is a first accompanying emitter;
the optical component is a first optical component; and
the light source module further comprises:
a second accompanying emitter configured to emit light through the window; and
a second optical component positioned at least partially over the second accompanying emitter
